(19) United States
(12) Patent Application Publication
(10) Pub. No.: US 2013/0260754 A1
(43) Pub. Date: Oct. 3, 2013

(54) APPARATUS AND METHOD FOR POWER CONTROL USING SMALL BASE STATIONS

(71) Applicant: ELECTRONICS AND TELECOMMUNICATIONS RESEARCH INSTITUTE, Daejeon (KR)

(72) Inventors: Seong Chul CHO, Daejeon (KR); Hyung Jin KIM, Daejeon (KR); Gweon Do JO, Daejeon (KR); Seung Hwan LEE, Daejeon (KR)

(73) Assignee: Electronics and Telecommunications Research Institute, Daejeon (KR)

(21) Appl. No.: 13/792,454

(22) Filed: Mar. 11, 2013

(30) Foreign Application Priority Data
Mar. 28, 2012 (KR) 10-2012-0031767

(51) Int. Cl. H04W 52/02

(52) U.S. Cl. CPC H04W 52/0206
USPC 455/435.1

(57) ABSTRACT

In a wireless communication system including a small base station and a macro base station, the small base station to perform power control may include: a user detector to detect a presence of a user terminal by monitoring whether a registration state of the user terminal served by the small base station corresponds to a registration complete state, a registration maintain state, or a registration release state; a control signal generator to generate a control signal for controlling power of at least one power device among a plurality of power devices included in a predetermined group, based on the detection result; and a control signal transmitter to transmit the control signal to the at least one power device among the plurality of power devices.

### CROSS-REFERENCE TO RELATED APPLICATION

This application claims the priority benefit of Korean Patent Application No. 10-2012-0031767, filed on Mar. 28, 2012, in the Korean Intellectual Property Office, the disclosure of which is incorporated herein by reference.

### BACKGROUND

1. Field of the Invention

The present invention relates to a technology of controlling power using a small base station such as a femto base station, and more particularly, to a technology of providing power usage efficiency through wired/wireless communication among a femto base station, a power supply device, and an electronic product.

2. Description of the Related Art

Currently, as an information technology has been increased and a multimedia technology has been widely distributed, a technology such as a femtocell that is installed indoors such as a house, an office, and the like to thereby guarantee mobility and large transmission through the convergence with an existing network is being developed.

In particular, a technology about a femtocell is present as a method for aggressively coping with a user request in an environment in which cell coverage is minimized to be a single space such as a room within a house or an office, decreasing an amount of time used to additionally install a cell, and reducing cost according to the cell operation.

In daily lives of people, power may be unnecessarily consumed by unnecessarily maintaining a power plug, an electronic product, and the like to be in a state connected to a power device. Accordingly, there is a need for a technology that may decrease unnecessary power usage and thus, may provide power usage efficiency by automatically controlling power of a power supply device and an electronic product.

### SUMMARY

An aspect of the present invention provides an apparatus and method that may decrease unnecessary power usage and thus, may provide power usage efficiency by automatically controlling power of a power device and an electronic product using power based on a user circumstance using a small base station technology.

According to an aspect of the present invention, there is provided a power control method of a small base station in a wireless communication system including the small base station and a macro base station, the method including: detecting a presence of a user terminal by monitoring whether a registration state of the user terminal served by the small base station corresponds to a registration complete state, a registration maintain state, or a registration release state; generating a control signal for controlling power of at least one power device among a plurality of power devices included in a predetermined group, based on the detection result; and transmitting the control signal to the at least one power device among the plurality of power devices.

The control signal may include a power device identifier (ID) field including an ID of each of the at least one power device, a small base station ID field including an ID of the small base station, and an ON/OFF field indicating one of power ON and power OFF of each of the at least one power device.

The power control method of the small base station may further include: maintaining a database that stores information about whether each of the plurality of power devices is in a power-ON state or a power-OFF state; and notifying the user terminal about a state of each of at least one power device among the plurality of power devices between the power-ON state and the power-OFF state.

The power control method of the small base station may further include: receiving, from the user terminal, a power-ON request or a power-OFF request for the at least one power device among the plurality of power devices; and generating the control signal in response to the power-ON request or the power-OFF request.

According to another aspect of the present invention, there is provided a power control method of a target power device among a plurality of power devices controlled through a wireless communication system including a small base station and a macro base station, the method including: receiving, from the small base station, a control signal for controlling power of the target power device; controlling a power ON/OFF device that performs power ON or power OFF of the target power device based on the control signal; and executing one of power ON and power OFF of the target power device through controlling of the power ON/OFF device. The control signal may include a power device ID field including an ID of the target power device, a small base station ID field including an ID of the small base station, and an ON/OFF field indicating one of power ON and power OFF of each of the at least one power device.

The controlling may include: detecting small base station ID field data from the received control signal; determining whether to ignore the control signal by comparing the detected small base station ID field data and a small base station ID that is pre-stored in a power device; detecting power device ID field data from the received control signal; determining whether to ignore the control signal by comparing the detected power device ID field data and a power device ID that is pre-stored in the power device; detecting power device ON/OFF field data from the received control signal; and transmitting a power-ON command or a power-OFF command to the power ON/OFF device based on the detected power device ON/OFF field data.

The controlling may include: detecting ID field data from the received control signal; determining whether to ignore the control signal by comparing the detected ID field data and an ID that is pre-stored in a power device; detecting power device ON/OFF field data from the received control signal; and transmitting a power-ON command or a power-OFF command to the power ON/OFF device based on the detected power device ON/OFF field data. The ID field data may include small base station ID field data and the power device ID field data, and the ID may include a small base station ID and a power device ID.

According to still another aspect of the present invention, there is provided a small base station to perform power control in a wireless communication system including the small base station and a macro base station, the small base station including: a user detector to detect a presence of a user terminal by monitoring whether a registration state of the user terminal served by the small base station corresponds to a registration complete state, a registration maintain state, or a registration release state; a control signal generator to generate a control signal for controlling power of at least one power device among a plurality of power devices included in a predetermined group, based on the detection result; and a control signal transmitter to transmit the control signal to the at least one power device among the plurality of power devices.

The control signal may include a power device ID field including an ID of each of the at least one power device, a small base station ID field including an ID of the small base station, and an ON/OFF field indicating one of power ON and power OFF of each of the at least one power device.

The small base station may further include: a database to store information about whether each of the plurality of power devices is in a power-ON state or a power-OFF state; and a notification unit to notify the user terminal about a state of each of at least one power device among the plurality of power devices between the power-ON state and the power-OFF state.

In response to the user terminal that is registered to the small base station, the control signal generator may generate a control signal for powering ON at least one power device among the plurality of power devices. In response to the user terminal of which registration is released from the small base station, the control signal generator may generate a control signal for powering OFF at least one power device among the plurality of power devices.

According to yet another aspect of the present invention, there is provided a target power device among a plurality of power devices controlled through a wireless communication system including a small base station and a macro base station, the target power device including: a control signal receiver to receive, from the small base station, a control signal for controlling power of the target power device; a power control unit to control a power ON/OFF device that performs power ON or power OFF of the target power device based on the control signal; and the power ON/OFF device to execute one of power ON and power OFF of the target power device through controlling of the power ON/OFF device. The control signal may include a power device ID field including an ID of the target power device, a small base station ID field including an ID of the small base station, and an ON/OFF field indicating one of power ON and power OFF of each of the at least one power device.

The power control unit may include: a small base station ID field data detecting unit to detect small base station ID field data from the received control signal; a base station ID comparing unit to determine whether to ignore the control signal by comparing the detected small base station ID field data and a small base station ID that is pre-stored in a power device; a power device ID field data detecting unit to detect power device ID field data from the received control signal; a power device ID comparing unit to determine whether to ignore the control signal by comparing the detected power device ID field data and a power device ID that is pre-stored in the power device; a power ON/OFF field data detecting unit to detect power device ON/OFF field data from the received control signal; and a power ON/OFF control unit to transmit a power-ON command or a power-OFF command to the power ON/OFF device based on the detected power device ON/OFF field data.

The power control unit may include: an ID field data detecting unit to detect ID field data from the received control signal; an ID comparing unit to determine whether to ignore the control signal by comparing the detected ID field data and an ID that is pre-stored in a power device; a power ON/OFF field data detecting unit to detect power device ON/OFF field data from the received control signal; and a power ON/OFF control unit to transmit a power-ON command or a power-OFF command to the power ON/OFF device based on the detected power device ON/OFF field data. The ID field data may include small base station ID field data and the power device ID field data, and the ID may include a small base station ID and a power device ID.

According to embodiments of the present invention, it is possible to automatically control power of an in-house power device and an electronic product based on a user circumstance using a small base station technology. Therefore, it is possible to reduce unnecessary power usage and to provide power usage efficiency. Also, since the power may be automatically controlled without a need for a user to manually control the power, it is possible to provide the user with the user convenience.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a femto base station that is an example of a small base station and a plurality of power devices (*according to an embodiment of the present invention;

FIG. 2 is a bock diagram illustrating a small base station according to an embodiment of the present invention;

FIG. 3 is a diagram illustrating a data format of a control signal according to an embodiment of the present invention;

FIG. 4 is a block diagram illustrating a power device according to an embodiment of the present invention;

FIG. 5 is a flowchart illustrating a power control method according to an embodiment of the present invention;

FIG. 6 is a flowchart illustrating a power control method according to another embodiment of the present invention; and

FIG. 7 is a block diagram illustrating a power control unit of a power device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

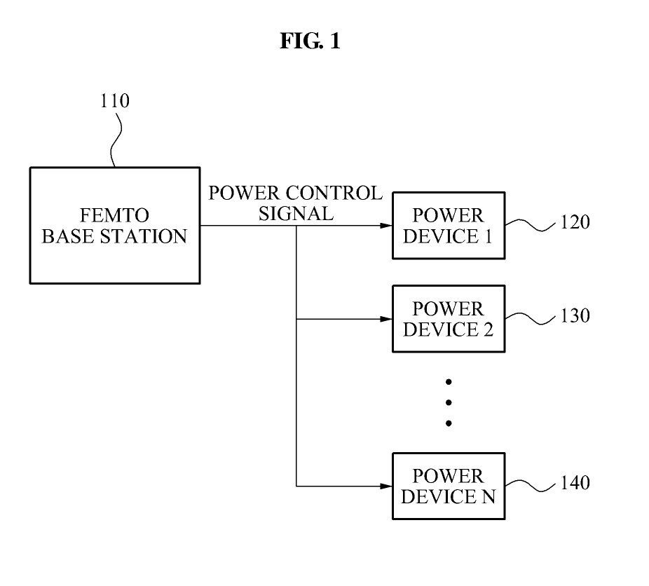

FIG. 1 is a diagram illustrating a femto base station that is an example of a small base station and a plurality of power devices (*according to an embodiment of the present invention.

Referring to FIG. 1, a system according to an embodiment of the present invention may include a femto base station 110 and N power devices 120, 130, and 140. The femto base station 110 is an example of a small base station and thus, the present invention is not limited thereto.

A user terminal that supports wireless communication, for example, a smart phone, a notebook, a tablet personal computer (PC), and the like, may be served by the femto base station 110 as well as a macro base station. Accordingly, the user terminal may achieve a high data rate and may utilize a high quality multimedia service. In addition, it is possible to solve a problem occurring due to a poor reception area of the macro base station.

Even though a description will be made below, the femto base station 110 may detect a presence of the user terminal by monitoring a state of the user terminal being served, and may control power of at least one power device among the N power devices 120, 130, and 140 that are included in a predetermined group, based on the detection result. For example, when the presence of the user terminal is detected within an area, for example, a house, an office, and the like, served by the femto base station 110, the N power devices 120, 130, and 140 may be powered ON. On the contrary, when the presence of the user terminal is detected outside the area, for example, the house, the office, and the like, served by the femto base station 110, the N power devices 120, 130, and 140 may be powered OFF.

In particular, to determine whether the user terminal is present within a predetermined area, the femto base station 110 of the present invention may monitor whether the user terminal is registered to the femto base station 110, whether registration of the user terminal to the femto base station 110 is being maintained, or whether the registration of the user terminal to the femto base station 110 is released.

The femto base station 110 may transmit a control signal to the N power devices 120, 130, and 140 based on the detection result. Power of the N power devices 120, 130, and 140 may be powered ON or OFF based on the control signal. In this instance, the present invention may provide a control signal having an appropriate data format, which will be further described below.

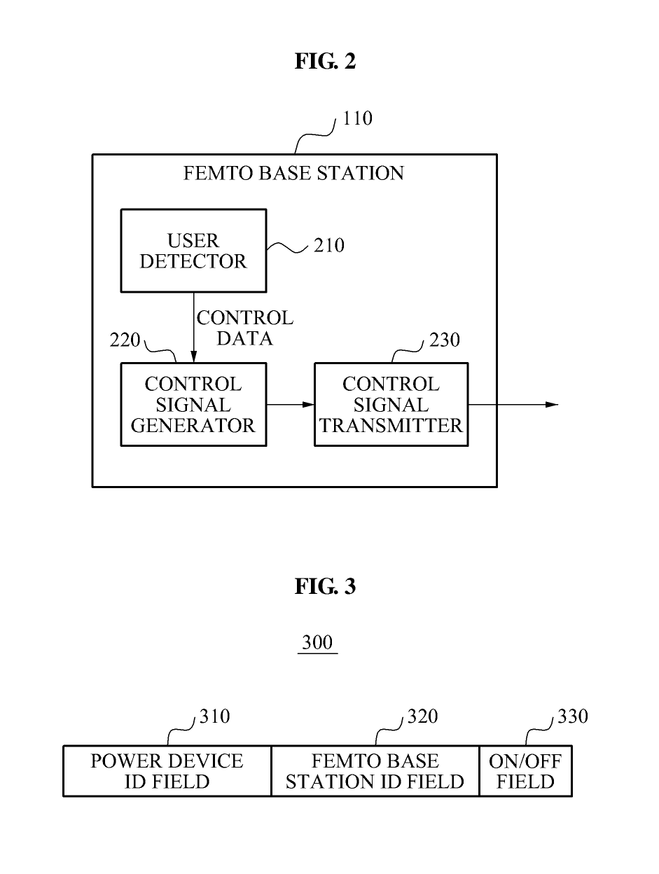

FIG. 2 is a bock diagram illustrating a small base station according to an embodiment of the present invention.

Referring to FIG. 2, as an example of the small base station, the femto base station 110 may include a user detector 210, a control signal generator 220, and a control signal transmitter 230.

The user detector 210 may detect a presence of a user terminal by monitoring a state of the user terminal being served by the femto base station 110. Here, the user detector 210 may monitor whether the user terminal is registered. In general, the user terminal may perform registration with respect to a base station of a corresponding cell based on a location of the user terminal. Accordingly, when the user terminal is moved from the house, the user terminal may be handed over from the femto base station 110 to the macro base station. That is, when the user terminal is moved from the house, the registration of the user terminal may be released from the femto base station 110 and registration of the user terminal may be completed in the macro base station. Accordingly, the femto base station 110 may be aware of whether the user terminal is positioned within the house, depending on whether the user terminal is registered to the femto base station 110. When the user terminal is registered to the femto base station 110, the user detector 210 may transmit control data corresponding to “ON” to the control signal generator 220. When the registration of the user terminal is released from the femto base station 110, the user terminal 210 may transmit control data corresponding to “OFF” to the control signal generator 220.

The control signal generator 220 may generate a control signal for controlling power of at least one power device among a plurality of power devices included in a predetermined group, based on the detection result.

That is, the control signal generator 220 may generate a control signal to be transferred to the plurality of power devices, based on control data that is received from the user detector 210. A plurality of power devices may be present within a house and thus, the control signal may include a power device identifier (ID) capable of identifying a corresponding power device. Also, to prevent an error of controlling a neighboring in-house power device by causing interference in a neighboring femto base station, the control signal may include a femto base station ID capable of identifying a corresponding femto base station.

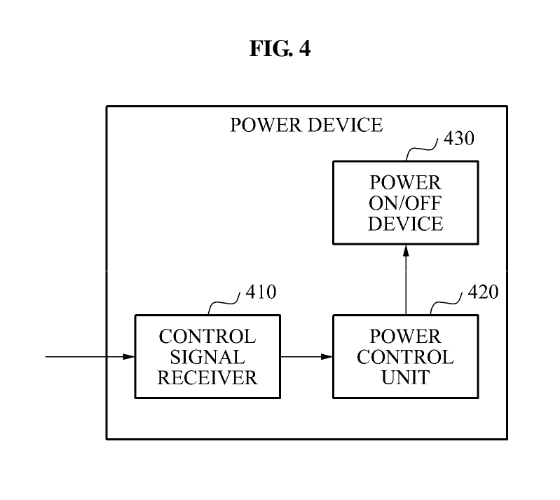

Accordingly, the control signal may include a power device ID field, a small base station ID field, and an ON/OFF field, which will be further described with reference to FIG. 3.

The control signal transmitter 230 may transmit the generated control signal to power devices in a wireless or wired manner. A predetermined modulation scheme, encryption scheme, and the like may be applied to the control signal.

FIG. 3 is a diagram illustrating a data format of a control signal 300 according to an embodiment of the present invention.

Referring to FIG. 3, the control signal 300 may include a power device ID field 310, a femto base station ID field 320, and an ON/OFF field 330.

The power device ID field 310 may include an ID of a target power device. The femto base station ID field 320 may include an ID of a small base station. The ON/OFF field 330 may include an indicator indicating one of power ON and power OFF of the target power device.

Each power device may determine whether to ignore a control signal based on the power device ID field 310 and the femto base station ID field 320. That is, each power device may determine whether to ignore the control signal by comparing pre-stored power device ID and an ID of a corresponding small base station with information included in the power device ID field 310 and information included in the small base station ID field 320, respectively.

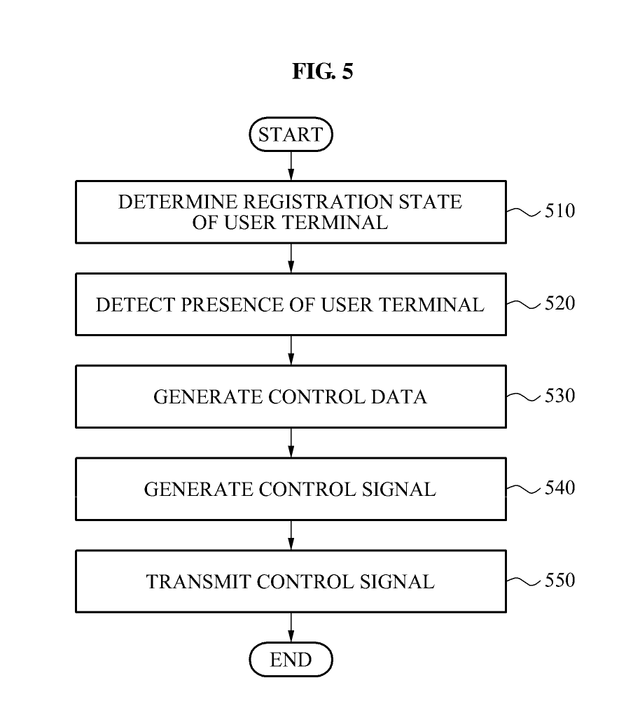

FIG. 4 is a block diagram illustrating a power device according to an embodiment of the present invention.

Referring to FIG. 4, the power device may include a control signal receiver 410, a power control unit, and a power ON/OFF device 430.

The control signal receiver 410 may receive, from a small base station, a control signal for controlling power of a target power device.

Also, the power control unit 420 may control the power ON/OFF device 430 that performs power ON or power OFF of the target power device, based on the control signal.

Also, the power ON/OFF device 430 may execute one of power ON and power OFF of the target power device through controlling of the power ON/OFF device 430.

The control signal receiver 410 may demodulate a control signal that is received from a femto base station. The demodulated control signal may be provided to the power control unit 420. The power control unit 420 may determine whether the control signal is transmitted from the corresponding femto base station by comparing a femto base station ID included in the received control signal and a pre-stored femto base station ID. When the control signal is not transmitted from the corresponding femto base station, the control signal may be ignored. When the femto base station ID included in the received control signal matches the pre-stored femto base station ID, the power control unit 420 may compare a received power device ID and a pre-stored power device ID. When the received power device ID is different from the pre-stored power device ID, the control signal may be ignored. On the contrary, when the received power device ID matches the pre-stored power device ID, the power control unit 420 may control the power ON/OFF device 430 based on an ON/OFF field.

FIG. 5 is a flowchart illustrating a power control method according to an embodiment of the present invention.

Referring to FIG. 5, in operation 510, a small base station may determine a registration state of a user terminal.

In operation 520, the small base station may detect a presence of the user terminal based on the registration state of the user terminal being served by the small base station.

In operation 530, the small base station may generate control data for controlling power of at least one power device among a plurality of power devices included in a predetermined group, based on the detection result.

The small base station may generate a control signal based on the control data in operation 540, and may transmit the control signal to power devices in operation 550.

Even though not illustrated in FIG. 5, the small base station may maintain a database that stores information about whether each of the plurality of power devices in a power-ON state or a power-OFF state. In this case, the small base station may notify the user terminal about a state of each of at least one power device among the plurality of power devices between the power-ON state and the power-OFF state.

Also, the small base station may receive, from the user terminal, a power-ON request or a power-OFF request with respect to at least one power device among the plurality of power devices. Here, a control unit of the small base station may generate the control signal in response to the power-ON request or the power-OFF request.

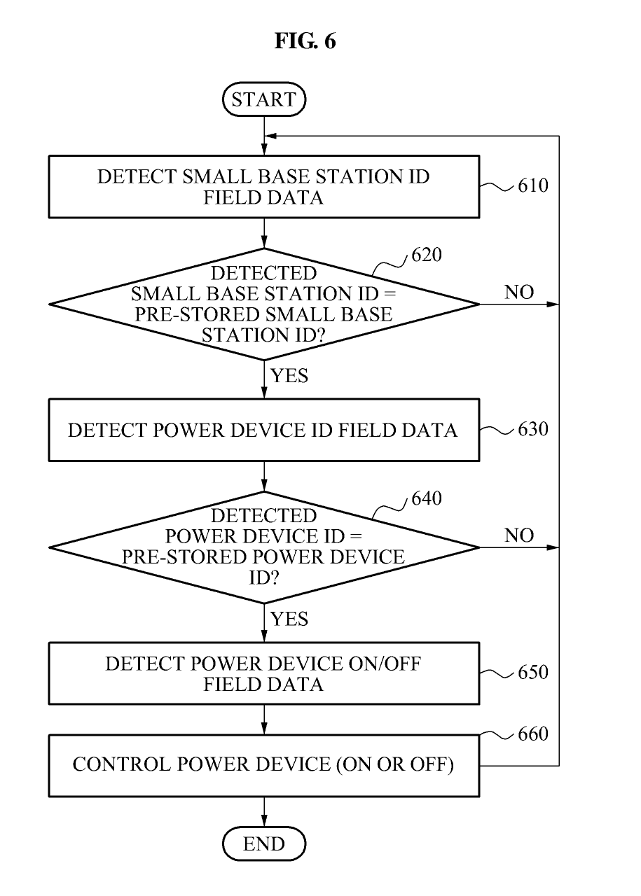

FIG. 6 is a flowchart illustrating a power control method according to another embodiment of the present invention.

When a power device receives a power signal, the power device may detect small base station ID field data from the received control signal in operation 610.

In operation 620, the power device may determine whether to ignore the control signal by comparing the detected small base station ID field data and a small base station ID that is pre-stored in the power device. That is, when the detected small base station ID field data and the small base station ID pre-stored in the power device mismatch, the control signal may be ignored and operation 610 may be performed. On the contrary, when the detected small base station ID field data and the small base station ID pre-stored in the power device match, the power device may detect power device ID field data from the received control signal in operation 630.

In operation 640, the power device may determine whether to ignore the control signal by comparing the detected power device ID field data and a power device ID that is pre-stored in the power device. That is, when the detected power device ID field data and the power device ID pre-stored in the power device mismatch, the control signal may be ignored and operation 610 may be performed. On the contrary, when the detected power device ID field data and the power device ID pre-stored in the power device match, the power device may detect power device ON/OFF field data from the received control signal in operation 650.

In operation 660, the power device may generate a power-ON command or a power-OFF command with respect to the power ON/OFF device based on the detected ON/OFF field data.

Here, the small base station ID field data and the power device ID field data may be integrated into single ID field data. The power device of the present invention may detect ID field data from the received control signal, and may determine whether to ignore the control signal by comparing the detected ID field data and an ID that is pre-stored in the power device. When the ID field data and the ID pre-stored in the power device match, the power device may detect power device ON/OFF field data from the received control signal and may transmit the power-ON command or the power-OFF command to the power ON/OFF device, based on the detected power device ON/OFF field data. Here, the small base station ID field data and the power device ID field data may be integrated into the ID field data, and the small base station ID and the power device ID may also be integrated into a single ID.

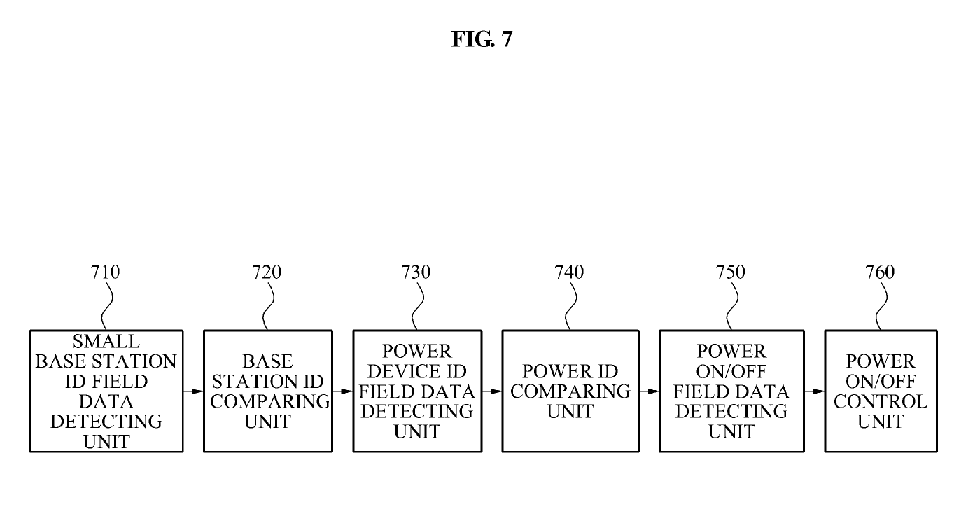

FIG. 7 is a block diagram illustrating a power control unit of a power device according to an embodiment of the present invention.

Referring to FIG. 7, the power control unit may include a small base station ID field data detecting unit 710, a base station ID comparing unit 720, a power device ID field data detecting unit 730, a power ID comparing unit 740, a power ON/OFF field data detecting unit 750, and a power ON/OFF control unit 760.

The small base station ID field data detecting unit 710 may detect small base station ID field data from a received control signal.

The base station ID comparing unit 720 may determine whether to ignore the control signal by comparing the detected small base station ID field data and a small base station ID that is pre-stored in a power device. When the small base station ID field data and the small base station ID pre-stored in the power device mismatch, the control signal may be ignored.

On the contrary, when the small base station ID field data and the small base station ID pre-stored in the power device match, the power device ID field data detecting unit 730 may detect the power device ID field data from the received control signal. The power device ID comparing unit 740 may determine whether to ignore the control signal by comparing the detected power device ID field data and a power device ID that is pre-stored in the power device.

When the detected power device ID field data and the power device ID pre-stored in the power device mismatch, the control signal may be ignored. On the contrary, when the detected power device ID field data and the power device ID pre-stored in the power device match, the power ON/OFF field data detecting unit 750 may detect power device ON/OFF field data from the received control signal.

Also, the power ON/OFF control unit 760 may generate a power-ON command or a power-OFF command with respect to the power ON/OFF device based on the detected power device ON/OFF field data.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A power control method of a small base station in a wireless communication system comprising the small base station and a macro base station, the method comprising:
detecting a presence of a user terminal by monitoring whether a registration state of the user terminal served by the small base station corresponds to a registration complete state, a registration maintain state, or a registration release state;
generating a control signal for controlling power of at least one power device among a plurality of power devices included in a predetermined group, based on the detection result; and
transmitting the control signal to the at least one power device among the plurality of power devices.

2. The method of claim 1, wherein the control signal comprises a power device identifier (ID) field including an ID of each of the at least one power device, a small base station ID field including an ID of the small base station, and an ON/OFF field indicating one of power ON and power OFF of each of the at least one power device.

3. The method of claim 1, further comprising:
maintaining a database that stores information about whether each of the plurality of power devices is in a power-ON state or a power-OFF state; and
notifying the user terminal about a state of each of at least one power device among the plurality of power devices between the power-ON state and the power-OFF state.

4. The method of claim 1, further comprising:
receiving, from the user terminal, a power-ON request or a power-OFF request for the at least one power device among the plurality of power devices; and
generating the control signal in response to the power-ON request or the power-OFF request.

5. A power control method of a target power device among a plurality of power devices controlled through a wireless communication system comprising a small base station and a macro base station, the method comprising:
receiving, from the small base station, a control signal for controlling power of the target power device;
controlling a power ON/OFF device that performs power ON or power OFF of the target power device based on the control signal; and
executing one of power ON and power OFF of the target power device through controlling of the power ON/OFF device,
wherein the control signal comprises a power device identifier (ID) field including an ID of the target power device, a small base station ID field including an ID of the small base station, and an ON/OFF field indicating one of power ON and power OFF of each of the at least one power device.

6. The method of claim 5, wherein the controlling comprises:
detecting small base station ID field data from the received control signal;
determining whether to ignore the control signal by comparing the detected small base station ID field data and a small base station ID that is pre-stored in a power device;
detecting power device ID field data from the received control signal;
determining whether to ignore the control signal by comparing the detected power device ID field data and a power device ID that is pre-stored in the power device;
detecting power device ON/OFF field data from the received control signal; and
transmitting a power-ON command or a power-OFF command to the power ON/OFF device based on the detected power device ON/OFF field data.

7. The method of claim 5, wherein the controlling comprises:
detecting ID field data from the received control signal;
determining whether to ignore the control signal by comparing the detected ID field data and an ID that is pre-stored in a power device;
detecting power device ON/OFF field data from the received control signal; and
transmitting a power-ON command or a power-OFF command to the power ON/OFF device based on the detected power device ON/OFF field data,
wherein the ID field data comprises small base station ID field data and the power device ID field data, and the ID comprises a small base station ID and a power device ID.

8. A small base station to perform power control in a wireless communication system comprising the small base station and a macro base station, the small base station comprising:
a user detector to detect a presence of a user terminal by monitoring whether a registration state of the user terminal served by the small base station corresponds to a registration complete state, a registration maintain state, or a registration release state;
a control signal generator to generate a control signal for controlling power of at least one power device among a plurality of power devices included in a predetermined group, based on the detection result; and
a control signal transmitter to transmit the control signal to the at least one power device among the plurality of power devices.

9. The small base station of claim 8, wherein the control signal comprises a power device identifier (ID) field including an ID of each of the at least one power device, a small base station ID field including an ID of the small base station, and an ON/OFF field indicating one of power ON and power OFF of each of the at least one power device.

10. The small base station of claim 8, further comprising:
a database to store information about whether each of the plurality of power devices is in a power-ON state or a power-OFF state; and
a notification unit to notify the user terminal about a state of each of at least one power device among the plurality of power devices between the power-ON state and the power-OFF state.

11. The small base station of claim 8, wherein:
in response to the user terminal that is registered to the small base station, the control signal generator generates a control signal for powering ON at least one power device among the plurality of power devices, and
in response to the user terminal of which registration is released from the small base station, the control signal generator generates a control signal for powering OFF at least one power device among the plurality of power devices.

12. A target power device among a plurality of power devices controlled through a wireless communication system comprising a small base station and a macro base station, the target power device comprising:
a control signal receiver to receive, from the small base station, a control signal for controlling power of the target power device;
a power control unit to control a power ON/OFF device that performs power ON or power OFF of the target power device based on the control signal; and
the power ON/OFF device to execute one of power ON and power OFF of the target power device through controlling of the power ON/OFF device,
wherein the control signal comprises a power device identifier (ID) field including an ID of the target power device, a small base station ID field including an ID of the small base station, and an ON/OFF field indicating one of power ON and power OFF of each of the at least one power device.

13. The target power device of claim 12, wherein the power control unit comprises:
a small base station ID field data detecting unit to detect small base station ID field data from the received control signal;
a base station ID comparing unit to determine whether to ignore the control signal by comparing the detected small base station ID field data and a small base station ID that is pre-stored in a power device;
a power device ID field data detecting unit to detect power device ID field data from the received control signal;
a power device ID comparing unit to determine whether to ignore the control signal by comparing the detected power device ID field data and a power device ID that is pre-stored in the power device;
a power ON/OFF field data detecting unit to detect power device ON/OFF field data from the received control signal; and
a power ON/OFF control unit to transmit a power-ON command or a power-OFF command to the power ON/OFF device based on the detected power device ON/OFF field data.

14. The target power device of claim 12, wherein the power control unit comprises:
an ID field data detecting unit to detect ID field data from the received control signal;
an ID comparing unit to determine whether to ignore the control signal by comparing the detected ID field data and an ID that is pre-stored in a power device;
a power ON/OFF field data detecting unit to detect power device ON/OFF field data from the received control signal; and
a power ON/OFF control unit to transmit a power-ON command or a power-OFF command to the power ON/OFF device based on the detected power device ON/OFF field data,
wherein the ID field data comprises small base station ID field data and the power device ID field data, and the ID comprises a small base station ID and a power device ID.
